(19) United States
(12) Patent Application Publication
(10) Pub. No.: US 2006/0146656 A1
(43) Pub. Date: Jul. 6, 2006

(54) Multi-component in-car video disc system

(76) Inventor: Claudio R. Laraia, Mohegan Lake, NY (US)

Correspondence Address: RICHARD C. CALDERWOOD, 2775 NW 126TH AVE, PORTLAND, OR, 97229-8381, US

(21) Appl. No.: 11/025,412

(22) Filed: Dec. 29, 2004

(51) Int. Cl. G11B 5/09

(52) U.S. Cl. 369/30.01; 369/47.1

(57) ABSTRACT

A bifurcated DVD player for custom aftermarket installation in automobiles. It includes a DVD reader which is thin and which can be mounted at any location in the vehicle convenient for the user, and a DVD electronics module which contains the bulkier power supplies, DVD decoder electronics, and the like, and which can be mounted at any other location in the vehicle because the user does not need access to it. The user inserts a DVD disc into the DVD reader, and controls the DVD player's operation via a remote control.

### BACKGROUND OF THE INVENTION

1. Technical Field of the Invention

This invention relates generally to in-car audio/video entertainment electronics, and more specifically to a DVD player having its disc reader separate and distinct from its video electronics.

2. Background Art

FIG. 1 illustrates an exemplary, conventional in-car DVD system 10, including a DVD player 12 coupled to a video display 14, such as a TFT LCD monitor, by a cable 16 such as an RCA cable or an S-Video cable or the like.

The DVD player includes a slot 18 into which a DVD disc 20 is inserted for playback. The DVD player includes a plurality of control buttons, knobs, etc. 22, and may optionally include a built-in display 24. In some instances, the built-in display is a simple, multi-line LCD for displaying control, programming, menuing, playback, and other such messages. In other instances, the built-in display may be e.g. a flip-out LCD monitor used for video display of the contents of the DVD disc.

FIG. 2 illustrates the in-car DVD system 10 in rear perspective view. The top cover of the DVD player 12 has been removed, showing the internal parts. When a DVD disc (not shown) is inserted through the slot 18, it is received into the DVD reader 26 (sometimes referred to as a DVD loader). The DVD reader is merely a disc drive, which reads the bits that are recorded on the disc. The DVD reader is shown partly cut away, for better visibility of the DVD player's other internal components. Furthermore, the DVD reader is shown as a greatly simplified “block”, as the details of its inner workings are not especially germane to understanding this invention, and are well known in the art.

The DVD player typically includes a main system board 28 which holds the various electronic components 30 such as power supplies, voltage regulators, processors, chips, capacitors, and so forth. These electronic components on the main system board perform various video processing operations upon the digital bits which are output by the DVD reader, and generate a digital or analog video signal which is provided over the video cable 16 to the video display 14. The DVD reader is coupled to the main system board by a cable 32.

The signal on that cable is typically a standard IDE interface signal, meaning that electronics (not shown) in the DVD reader have performed some low-level processing operations to convert the raw bit stream from the disc into an industry standard format representing sectors of data from the disc. The DVD reader in those systems includes the low-level control electronics for e.g. moving the laser head, rotating the spindle, and so forth. In some newer, cost-reduced systems, even those functionalities have been moved onto the main system board. The DVD reader in such systems outputs a demodulated data stream of the bits from the disc.

It is desirable that the DVD reader reside in a convenient location in the automobile (not shown), for example in the dashboard within easy reach of the driver, for ease in changing discs. Conventional in-car DVD players have typically been dash mounted in an industry standard Single DIN (2′ height) slot, and more recently in a Half DIN (1′) height slot. However, not all vehicles have suitable or unused dashboard slots into which an aftermarket DVD player can be added.

What is desirable, then, is an in-car DVD system which does not require a full Single DIN or Half DIN dashboard slot for mounting. What is further desirable is an in-car DVD system in which the critical-accessibility components can be mounted in any convenient location.

### BRIEF DESCRIPTION OF THE DRAWINGS

FIG. 1 is a front perspective view of a conventional in-car DVD system, illustrating the DVD player with its disc slot and its controls, and illustrating a separate LCD display coupled to the DVD player by a video cable.

FIG. 2 is a rear perspective view of the system of FIG. 1, illustrating the various inputs and outputs of the DVD player.

FIG. 3 is a front perspective view of one embodiment of an in-car DVD system according to this invention, illustrating that the DVD reader is a separate component from that which houses the DVD player electronics.

FIG. 4 is a rear perspective view of the system of FIG. 3, illustrating the various inputs and outputs of the components.

FIG. 5 is a front perspective view of the DVD electronics component of FIG. 3, with the top removed, showing exemplary internal electronic components.

FIG. 6 is a rear perspective view of the component of FIG. 5.

FIG. 7 is a front perspective view of an in-car computer and DVD system according to another embodiment of this invention.

FIG. 8 is a rear perspective view of the system of FIG. 7.

FIG. 9 is a front perspective view of an in-car computer and DVD system according to another embodiment of this invention, in which the computer is coupled directly to the DVD reader.

FIG. 10 is a rear perspective view of the system of FIG. 9.

FIG. 11 is a front perspective view of an in-car computer, DVD, and audio system according to another embodiment of this invention.

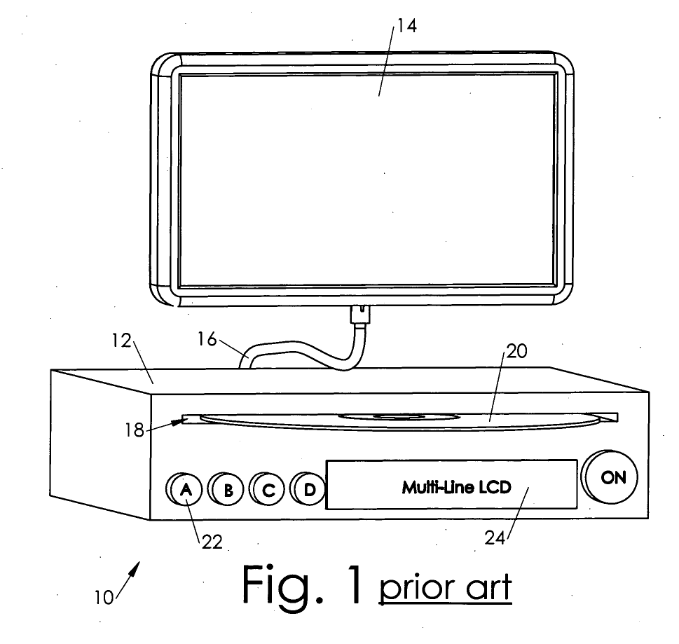

### DETAILED DESCRIPTION

The invention will be understood more fully from the detailed description given below and from the accompanying drawings of embodiments of the invention which, however, should not be taken to limit the invention to the specific embodiments described, but are for explanation and understanding only.

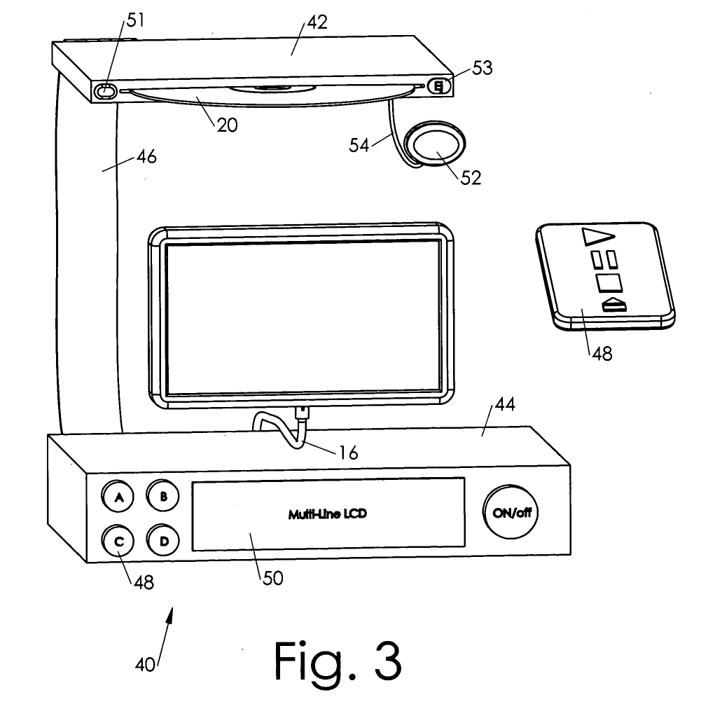

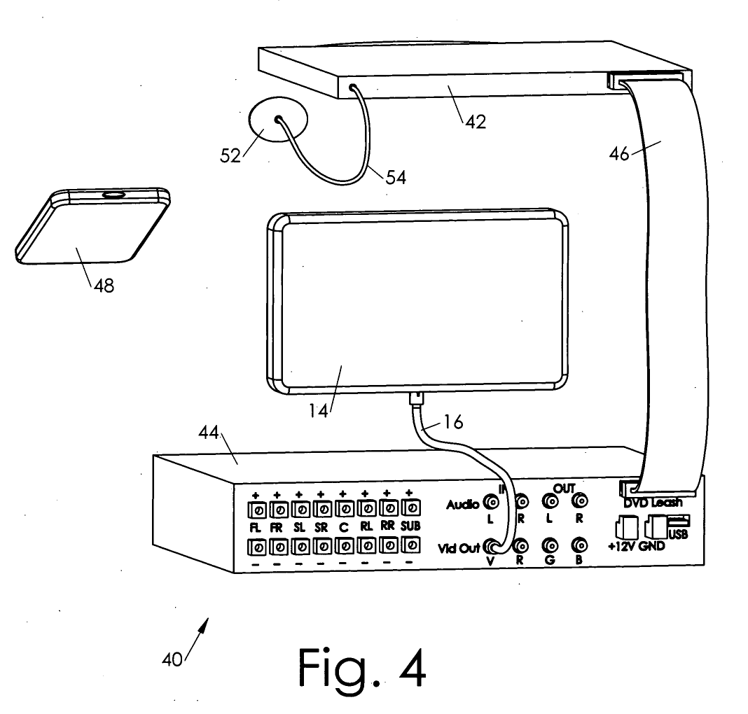

FIGS. 3 and 4 illustrate an in-car DVD system 40 according to one embodiment of this invention. The DVD system includes a DVD reader 42 which is coupled to a separate, distinct DVD electronics module 44 by a DVD leash or cable 46. In some embodiments, the DVD reader may communicate with the DVD electronics module via e.g. a wireless link such as a Bluetooth wireless channel. Wired and wireless connections may collectively be termed links. The DVD reader includes the laser mechanism for extracting a bit stream from the DVD, and, optionally, sufficient electronics to demodulate the bit stream. The DVD reader may, optionally, further include sufficient electronics to output e.g. an IDE format of data onto the leash. The DVD electronics module includes the electronic components (not shown) which generate the video signal, which is provided over a video cable 16 to a display 14. The display can be mounted at any suitable location for viewing.

Because the DVD disc is inserted into the DVD reader, not into the DVD electronics module, the DVD reader can be mounted at any convenient location in the vehicle, without regard for space requirements of the DVD electronics module. For example, the DVD reader can be mounted inside a factory flip-down visor, or in the headliner, or in a small housing affixed onto or into the headliner, or in the dashboard, or in or on a headrest of a seat, or wherever it may be handy for use in the particular vehicle.

The DVD electronics module can be mounted at any other suitable location, such as under a seat, in the trunk, or wherever it may be conveniently located, limited only by the ability of the electronics to provide adequate signal strength and quality to handle the length of the cable required.

In some embodiments, the DVD electronics module includes control knobs 48 and/or a display 50. In such instances, the DVD electronics module should be located where those items are accessible enough. In some instances, those items are not required for day-to-day operation of the system; e.g. they may be used only during system installation and setup. In some instances, even though the controls are required for day-to-day usage (such as a “Play” button), the same functionality may be provided by a wireless or wired remote control module 48.

The wireless remote control module may communicate with a receiver 51 which is built into the DVD reader, and/or a receiver 52 which is remotely located but is coupled to the DVD reader (or the DVD electronics module, for that matter) by a cable 54.

In other embodiments, various ones of the controls 51 may be located on the DVD reader. In one embodiment, the DVD reader has an eject button, as shown. In other embodiments, additional buttons may be included to facilitate commonly used features such as play, pause, and stop.

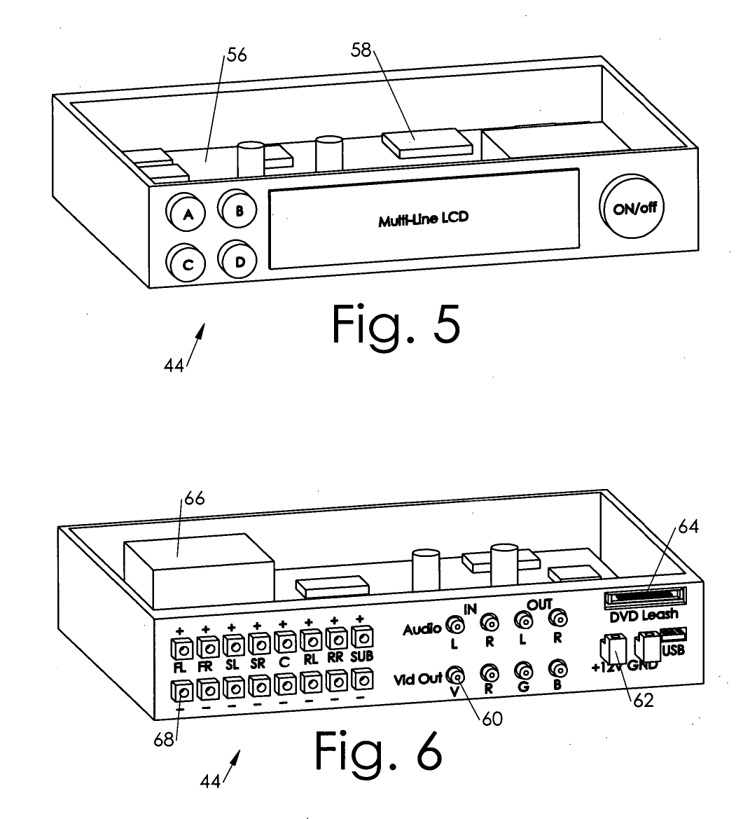

FIGS. 5 and 6 illustrate the DVD electronics module 44 with the top removed, showing the internal components. A main circuit board 56 holds the electronic components 58 which perform the various video processing and video signal generating functions of the DVD player system.

The DVD electronics module includes various audio/video input and output connectors 60 and a plurality of power and ground connectors 62 according to the needs of the application at hand. It also includes a DVD leash connector 64 for coupling to the DVD reader (not shown) via the leash cable (not shown).

Optionally, the DVD player system may also function as an audio system. In that case, the DVD electronics module may optionally include an audio amplifier 66 coupled to drive a plurality of audio loudspeaker outputs 68.

In some embodiments, the DVD reader is less than 1/2′ thick. In some embodiments, the DVD electronics module is greater than 1/2′ thick; in some such embodiments, it is greater than 1′ thick, and in some it is greater than 1.5′ thick.

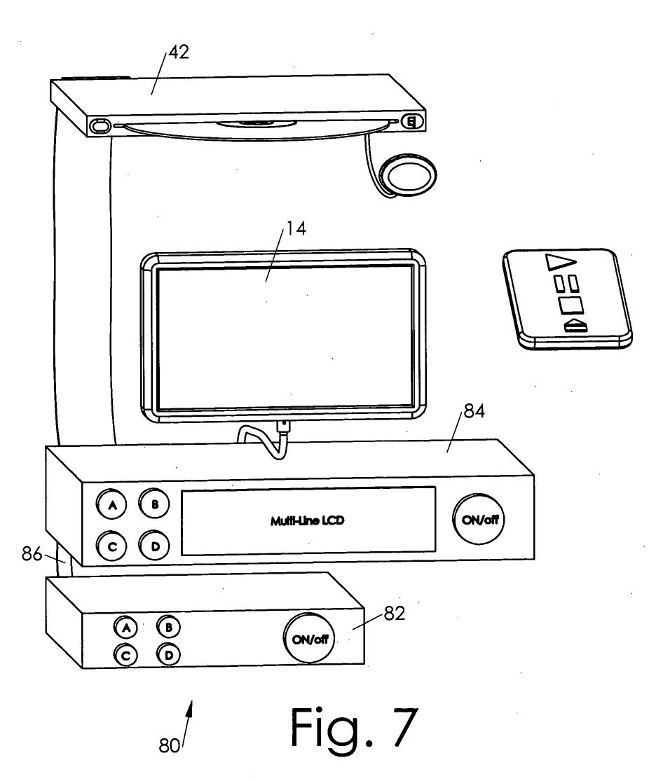

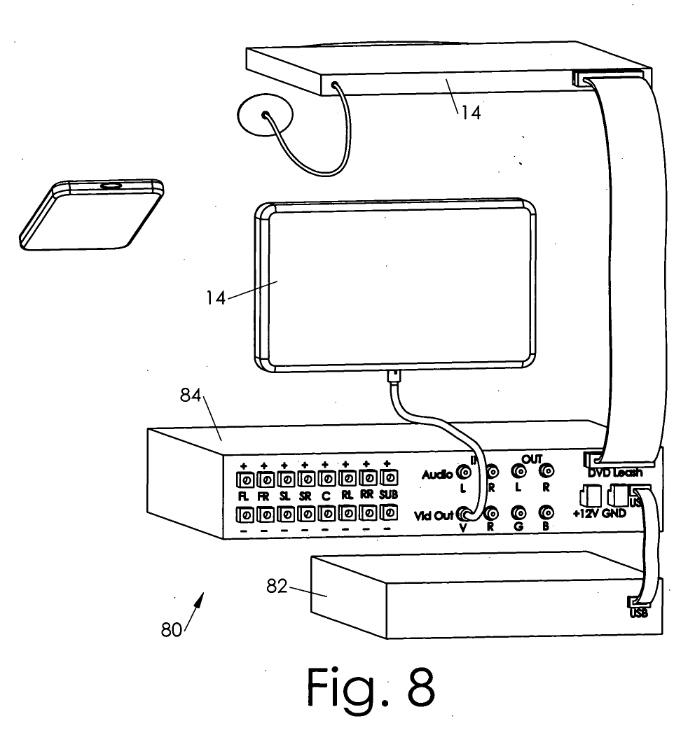

FIGS. 7 and 8 illustrate an in-car computer video system 80 according to another embodiment of this invention. The computer video system includes a DVD reader 42 which is separate and distinct from its DVD electronics module 84, and a display 14 which is coupled to be driven with a video signal from the DVD electronics module.

Additionally, the system includes an in-car personal computer (PC) 82 which is coupled to the DVD electronics module such as via a USB or FireWire cable 86. The in-car PC uses the DVD system as its DVD-ROM for reading and/or writing data. The partitioning of the DVD system into a DVD electronics module and a separate DVD reader is invisible to the PC. The PC simply sees an external DVD drive attached to its USB port.

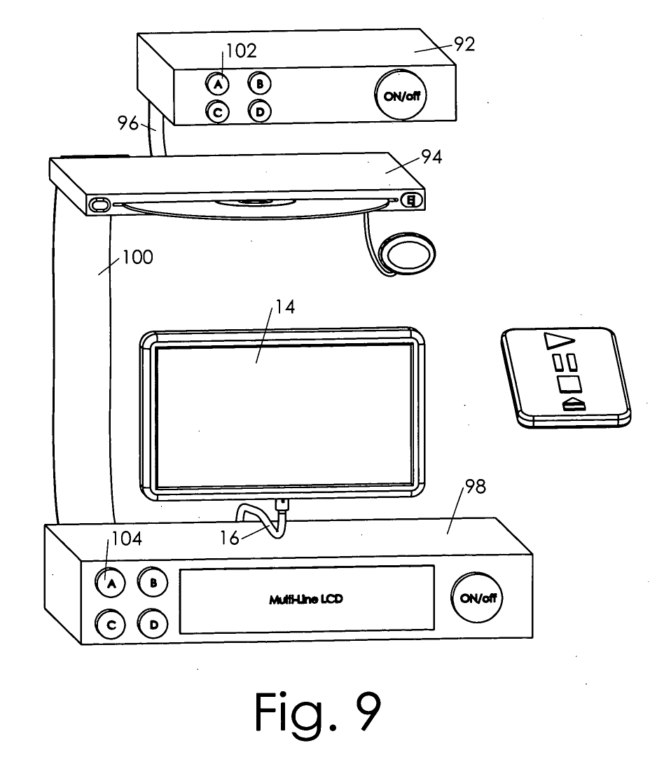

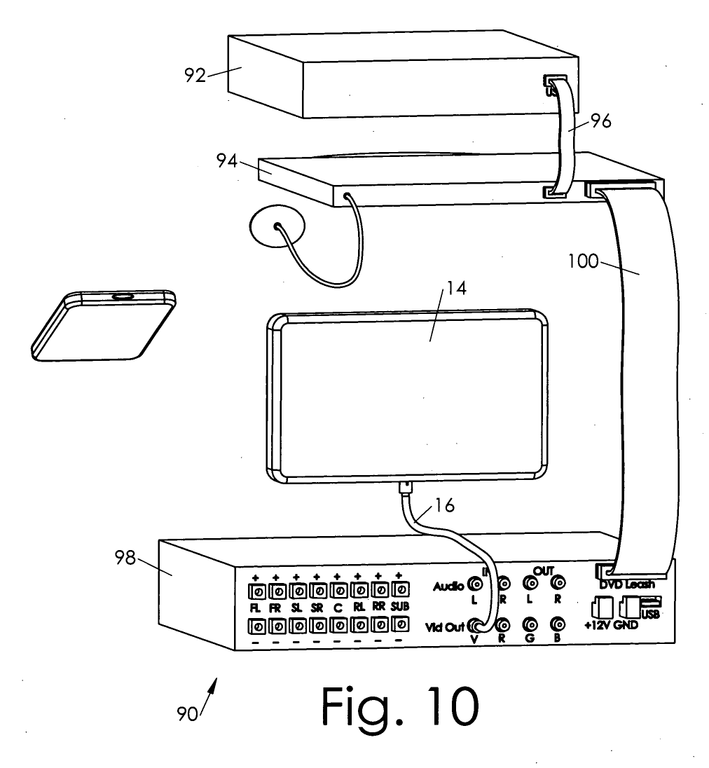

FIGS. 9 and 10 illustrate another in-car computer video system 90 according to another embodiment of this invention. In this system, the PC 92 is coupled directly to the DVD reader 94 such as by a USB, FireWire, SATA, ATA, or other such cable 96. The PC utilizes the DVD reader very much in the same manner that a conventional laptop computer accesses an internal DVD-ROM drive. The system also includes a DVD electronics module 98 which is coupled to the DVD reader by a suitable interface cable 100, and which is coupled to provide a video signal to a display unit 14.

If the PC is also equipped to play DVD movies, meaning that the PC is equipped to read the bit stream from the DVD reader and from it generate a video signal, that video signal may be provided to the display 14 via the cable 96 and the cable 100 and the cable 16 in series; alternatively, the video signal may be provided directly to the display by a dedicated cable (not shown). In some such embodiments, the PC may generate video signals from sources other than the DVD reader, such as from MPEG clips stored on its internal hard drive (not shown). In some embodiments, the PC may output a bit stream (either via the cables 96 and 100, or via a dedicated cable which is not shown) to the DVD electronics module, which then generates a video signal from that bit stream and provides the video signal to the display. The PC may use the display 14 for other, more conventional PC display functions, such as displaying data and conventional graphical user interface windows and the like.

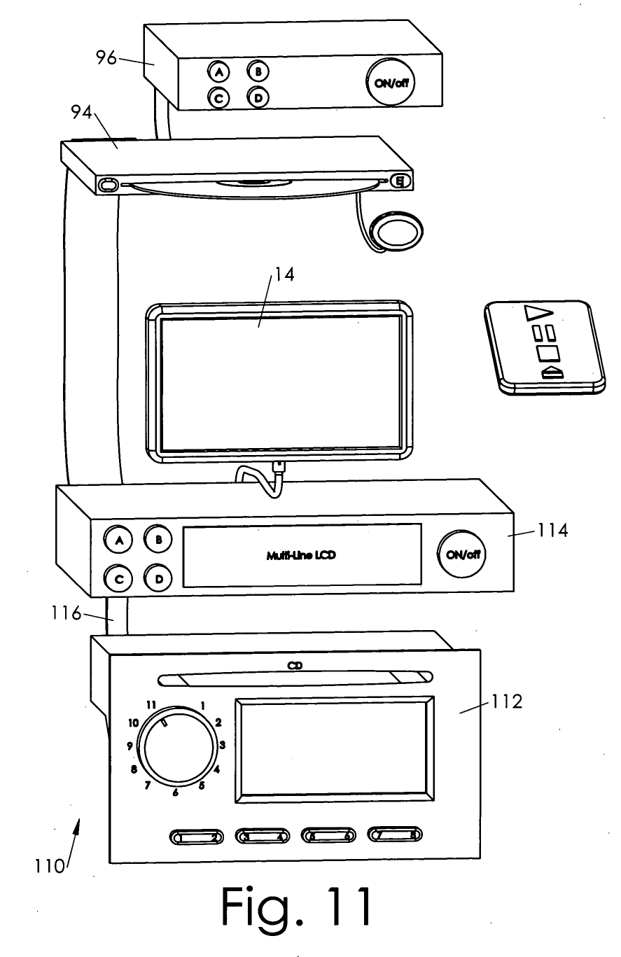

FIG. 11 illustrates an in-car computer, DVD, and audio system 110 according to another embodiment of this invention. The system includes an audio head unit 112 which provides any combination of the conventional car audio features, such as FM radio, AM radio, satellite radio, CD, cassette tape, and so forth. The DVD electronics module appears to the head unit as a complete DVD player, and the DVD reader appears to the computer as an attached DVD-ROM drive.

In some embodiments, the DVD reader auto-configures itself, according to what type of disc is inserted. If a DVD movie disc is inserted, the DVD reader configures itself to function as part of a DVD player in conjunction with the DVD electronics module and the head unit (which is used for playing the audio from the disc). If a DVD-R, DVD+RW, etc. data disc is inserted, the DVD reader configures itself to communicate with the computer and behave as a DVD-ROM etc. drive, without needing the DVD decode etc. circuitry which is in the DVD electronics module.

In some embodiments, the configuration is manually implemented by e.g. the user pressing a mode switch or button on the computer, the DVD reader, the display, the remote, or the head unit (or, less desirably, on the DVD electronics module).

While the DVD reader is in the DVD-ROM mode, the head unit continues to operate normally. In some embodiments, the head unit may continue to use the audio amplifier in the DVD electronics module even though the DVD reader is operating as a DVD-ROM drive for the PC and the display is operating as the PC's output display device rather than as a movie display.

### CONCLUSION

Because those of ordinary skill in the car audio/video electronics field are intimately familiar with automobiles and with the installation of car electronics in automobiles, the automobile itself has been omitted from the drawings.

The particular video and audio input and output signals shown in the drawings are for illustration only, and should not be considered limiting of the invention.

Although the invention has been described in terms of a DVD disc and DVD player, the invention should not be misunderstood as being limited to DVDs specifically. The invention may be used in a variety of disc formats, sizes, encodings, and so forth. The invention may be used with optical discs such as DVDs, HD-DVDs, or BluRay discs, or it may be used with e.g. magnetic recording disks.

In some embodiments, the DVD reader may be an extremely thin single-disc unit. In other embodiments, the DVD reader may be a slightly thicker (e.g. Half DIN) multi-disc changer accommodating a plurality of video discs, or a plurality of data discs, or a combination of video discs and data discs.

While the invention has been described with reference to embodiments in which a single DVD reader is coupled to the DVD electronics module, in other embodiments the DVD electronics module can have sufficiently many and/or powerful video circuits, such that the single DVD electronics module can be coupled to operate with a plurality of DVD readers. And while the invention has been described with reference to embodiments including a single video display monitor, this enhanced DVD electronics module can be capable of driving two or more monitors, either with multiple copies of the same video signal, with unique, individual video signals, or with any combination thereof. For example, a single DVD electronics module mounted under a seat can serve separate DVD readers located at each seating position, and provide a corresponding video signal to a display located at each seating position. In some instances, two or more viewers may wish to simultaneously watch a single copy of a given DVD movie disc. In such cases, the DVD electronics module and/or the displays and/or the DVD readers can be equipped with a video stream selection control button whereby the viewer can select among multiple video streams originating from the various other DVD readers.

The invention has been described with reference to its inclusion in a car or an automobile. This should not be considered limiting of the invention, as the invention may also be utilized in a variety of other motor vehicles, such as motorcycles, boats, or trucks.

When one component is said to be “adjacent” another component, it should not be interpreted to mean that there is absolutely nothing between the two components, only that they are in the order indicated.

The various features illustrated in the figures may be combined in many ways, and should not be interpreted as though limited to the specific embodiments in which they were explained and shown.

Those skilled in the art having the benefit of this disclosure will appreciate that many other variations from the foregoing description and drawings may be made within the scope of the present invention. Indeed, the invention is not limited to the details described above. Rather, it is the following claims including any amendments thereto that define the scope of the invention.

What is claimed is:

1. A video electronics system for installation in a vehicle, the video electronics system comprising:
a video disc reader having an output for providing a data stream;
a link having a first end coupled to the video disc reader output and having a second end; and
a video disc electronics module having,
an input coupled to the second end of the link for receiving the data stream from the video disc reader,
electronics coupled to the input to receive the data stream and for generating from the data stream a video output signal, and
an output coupled to the electronics for providing the video output signal.

2. The video electronics system of claim 1 further comprising:
a video display having an input coupled to the output of the video disc electronics module for displaying a video image in response to the video output signal.

3. The video electronics system of claim 1 further comprising:
a wireless remote control unit for generating wireless remote control signals; and
a receiver for receiving the wireless remote control signals;
wherein at least one of the video disc reader and the video disc electronics module is responsive to the wireless remote control signals received by the receiver.

4. The video electronics system of claim 3 wherein:
the receiver is built into the video disc reader.

5. The video electronics system of claim 3 wherein:
the receiver comprises a separate receiver unit which is coupled to one of the video disc reader and the video electronics module by a wire.

6. The video electronics system of claim 1 wherein:
the video disc reader includes exactly one control input button; and
that control input button comprises an EJECT button which causes the video disc reader to eject a video disc from the video disc reader.

7. The video electronics system of claim 1 wherein:
the link comprises an IDE cable; and
the video disc reader provides the data stream as an IDE data stream.

8. The video electronics system of claim 1 wherein:
the video electronics module further includes,
audio amplifier circuitry, and
audio loudspeaker outputs coupled to the audio amplifier circuitry.

9. The video electronics system of claim 1 wherein:
the video electronics module further includes outputs for providing the video signal in a plurality of video signal formats.

10. The video electronics system of claim 9 wherein the plurality of video signal formats comprises at least two of:
a composite video signal;
RGB video signals;
YUV video signals;
component video signals;
HDMI video signals;
VGA video signals;
DVI video signals;
S-video video signals; and
USB video signals.

11. The video electronics system of claim 1 wherein:
the video disc reader comprises a DVD reader; and
the electronics of the video electronics module comprise DVD decode circuitry.

12. The video electronics system of claim 1 further comprising:
an in-car computer coupled to the video disc reader to access the video disc reader as a disc drive.

13. The video electronics system of claim 1 wherein:
an in-car computer coupled to the video electronics module.

14. An in-car video disc system comprising:
a video disc reader less than one half inch thick and having an output for providing a bit stream of data from a video disc;
a video disc electronics module having,
an input,
video disc decoder circuitry for generating a video signal in response to the bit stream from the video disc reader, and
an output;
a data cable coupling the output of the video disc reader to the input of the video disc electronics module;
a flat panel display having an input; and
a video cable coupling the output of the video disc electronics module to the input of the flat panel display.

15. The in-car video disc system of claim 14 further comprising:
a personal computer coupled to the video disc reader to access the video disc reader as an internal data disc drive.

16. The in-car video disc system of claim 14 further comprising:
a personal computer coupled to the video disc electronics module to access the video disc electronics module and video disc reader as an external data disc drive.

17. The in-car video disc system of claim 14 further comprising:
an audio head unit coupled to the video disc electronics module to access the video disc reader and video disc electronics module as a data disc drive storing music for play under control of the head unit.

18. The in-car video disc system of claim 14 wherein:
the video disc comprises a DVD disc.

19. The in-car video disc system of claim 14 further comprising:
a plurality of video disc readers coupled to the video disc electronics module.

20. The in-car video disc system of claim 14 wherein the video disc reader comprises:
a multi-disc changer.

21. A video disc player comprising:
(a) a video disc reader including,
a laser system for reading a video disc,
first electronics coupled to the laser system for extracting a bit stream from an output of the laser system,
an output coupled to the first electronics for transmitting the bit stream; and
(b) a video disc electronics module including,
second electronics having an input coupled to the output of the video disc reader for processing the transmitted bit stream to generate a video signal, and
an output coupled to the second electronics for providing the video signal.

22. The video disc player of claim 21 further comprising:
a display having an input coupled to the output of the video disc electronics for displaying an image according to the video signal.
